(19) United States
(12) Patent Application Publication
(10) Pub. No.: US 2005/0166724 A1
(43) Pub. Date: Aug. 4, 2005

(54) Twisted and tapered driver for a threaded fastener

(75) Inventor: Javier Castaneda, Miami, FL (US)

Correspondence Address: David S. Jacobson;Gordon & Jacobson, P.C., 65 Woods End Road, Stamford, CT, 06905, US

(73) Assignee: Hand Innovations, Inc.

(21) Appl. No.: 10/767,128

(22) Filed: Jan. 29, 2004

(51) Int. Cl. B25B 13/48

(52) U.S. Cl. 81/436

(57) ABSTRACT

A driver includes a polygonal cross-sectional shape which is both tapered and twisted by a defined degree so that in an end view the largest polygonal cross-sectional shape circumscribes the smallest polygonal cross-sectional shape such that the corners of the smallest polygonal cross-sectional shape lies at the sides of the largest polygonal cross-sectional shape. This twisting and tapering configuration facilitates engagement within a fastener socket and provide planar contact along each side of the polygonal shape as well as along the edges of the tapering portion.

### BACKGROUND OF THE INVENTION

1. Field of the Invention

This invention relates broadly to tools. More particularly, this invention relates to tools having a work engaging and force exerting portion adapted to be inserted into a socket of a threaded fastener.

2. State of the Art

Various tools are known for inserting threaded fasteners such as screws. Where the fasteners have square or hexagonally shaped sockets, drivers having a tip with a generally like shape are provided for use therewith and can provide a rotational force to the fastener to secure the fastener to, e.g., a medical implant, human tissue, or other workpiece.

Particularly for small fasteners, it is desirable that the driver tip be relatively easily inserted into the socket of the fastener and the driver tip retain the fastener on the tip via interference.

One simple manner to retain the fastener is to use a tapered tip end on the driver which wedges into the socket of the fastener to provide an interference fit. However, the disadvantage of such an arrangement is that the driver engages the fastener only at the outer edge of the socket. This results in inefficient transfer of the torque from the driving member to the fastener. Also, the concentration of force at one contact location tends to wear and deform the socket and driving member in the contact region. Furthermore, it has been found that very close tolerances are necessary in order to provide the proper wedge fit in a consistent manner.

In an improvement to such a driver, U.S. Pat. No. 5,105,690 to Lazzara et al. discloses a driver having a tip with a length shorter than a socket of the fastener and a flared portion above the tip. The tip fits relatively easily into the socket and includes facets which effect the transmission torque against the sides of the socket for rotational movement of the fastener. The flared portion of the driver creates a frictional engagement with the upper edge of the socket which holds the fastener to the driver until the fastener is secured to a workpiece such as a dental fixture.

U.S. Pat. No. 4,970,922 to Krivec discloses a driver for a threaded fastener which is designed to increase retention of the fastener on the driver while increasing the contact region imparting the torque. The tip of the driver includes a plurality of circularly helical driving portions projecting laterally from the body and equiangularly spaced about the axis, wherein the helix angle is less than six degrees. The socket of the fastener includes a plurality a radial lobes defining a star-like shape, with each slot adapted to receive one of the helical projections. The driving portions are smaller in section than the radial lobes facilitating insertion of the tip of the driver into the socket. However, referring to FIG. 5 of U.S. Pat. No. 4,970,922, the helical twist to the driver tip limits each edge of a driving portion to only two lines of contact against a corresponding lobe, at a leading lower edge and an upper trailing edge. This limited contact provides less than desirable force transmission. In addition, depending on the relative material hardnesses of the driver and the fastener, there will be undue strain at the lines of contact on at least one of the driver and fastener. Furthermore, the laterally projecting driving portions are subject to torque, and force that would otherwise be applied to rotation of the fastener will be transferred to bending of the driving portions.

### SUMMARY OF THE INVENTION

It is therefore an object of the invention to provide a driver which can be relatively easily inserted into a socket of fastener.

It is another object of the invention to provide a driver which contacts the socket along its sides.

It is a further object of the invention to provide a driver which contacts the socket along the corners of the driver.

It is also an object of the invention to provide a driver which provides excellent torque transmission.

It is still another object of the invention to provide a driver which frictionally engages the socket of the fastener.

In accord with these objects, which will be discussed in detail below, a driver includes a regular polygonal cross-sectional shape which is both tapered and twisted by a defined degree so that in an end view the largest polygonal cross-sectional shape circumscribes the smallest polygonal cross-sectional shape such that the corners of the smallest polygonal cross-sectional shape lies at the sides of the largest polygonal cross-sectional shape. This twisting and tapering configuration facilitates engagement within a fastener socket and provide planar contact between portions of the driver and the facets of the socket.

In accord with a preferred aspect of a hexagonal driver according to the invention, the degree of taper and the twist angle are such that as the driver angularly extends from the smaller distal hexagon to the larger proximal hexagon, with the smaller and larger hexagons being rotationally offset. The corner edges of the smaller hexagon are longitudinally aligned with the sides of the larger hexagon. The corner edges of the hexagons lie in planes parallel to the longitudinal axis of the hexagon. This permits the edges to dig themselves evenly into the facets of the fastener socket.

The principle applies to other regular polygonal shaped drivers including, by way of example, square drivers.

With the above driver, easy insertion is provided into a fastener socket, the fastener is retainer on the driver, and the driver provides planar contacts against the socket along each of its sides to impart excellent torque transmission to the fastener.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view of a driver according to invention;

FIG. 2 is an enlarged perspective distal section of the driver of FIG. 1;

FIG. 3 is an enlarged end view of the driver of FIG. 1;

FIG. 4 is an enlarged side elevation section of the driver of FIG. 1;

FIG. 5 is a schematic view of the driver tip inserted into a socket of fastener;

FIG. 6 is a schematic of the hexagonal twisted and tapered driver tip, corresponding to FIG. 3;

FIG. 7 is a schematic of the hexagonal tapered driver tap, shown without twist, corresponding to FIG. 4;

FIG. 8 shows the geometric relationship between various angles and sides of the twisted and tapered driver of FIGS. 1 through 4; and

FIGS. 9 and 10 are schematics of a square twisted and tapered driver according to another embodiment of the invention.

### DETAILED DESCRIPTION OF THE PREFERRED EMBODIMENTS

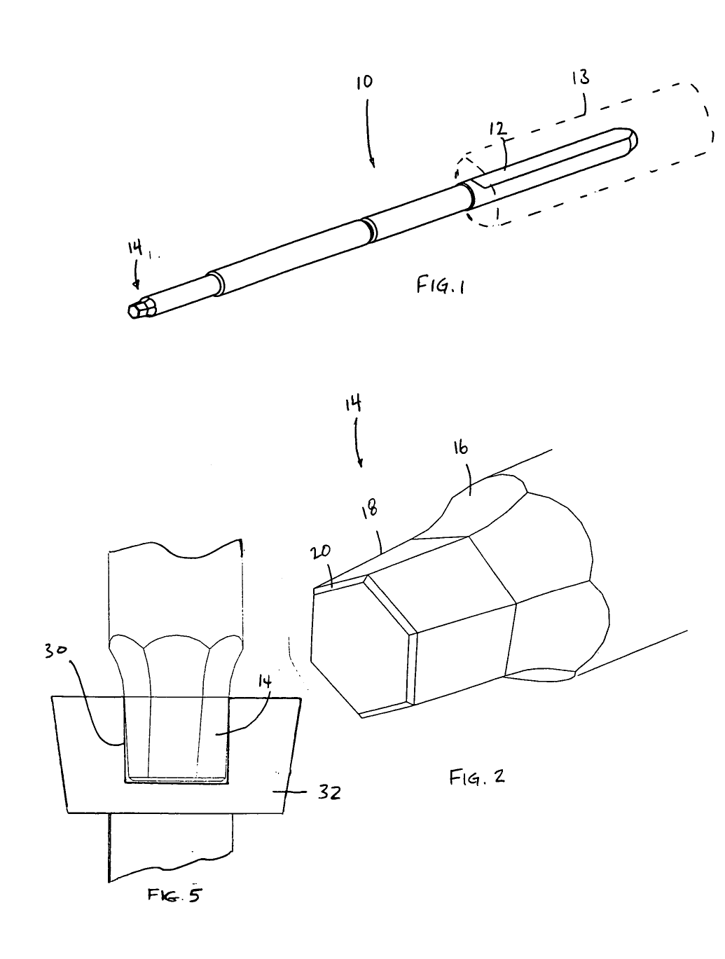

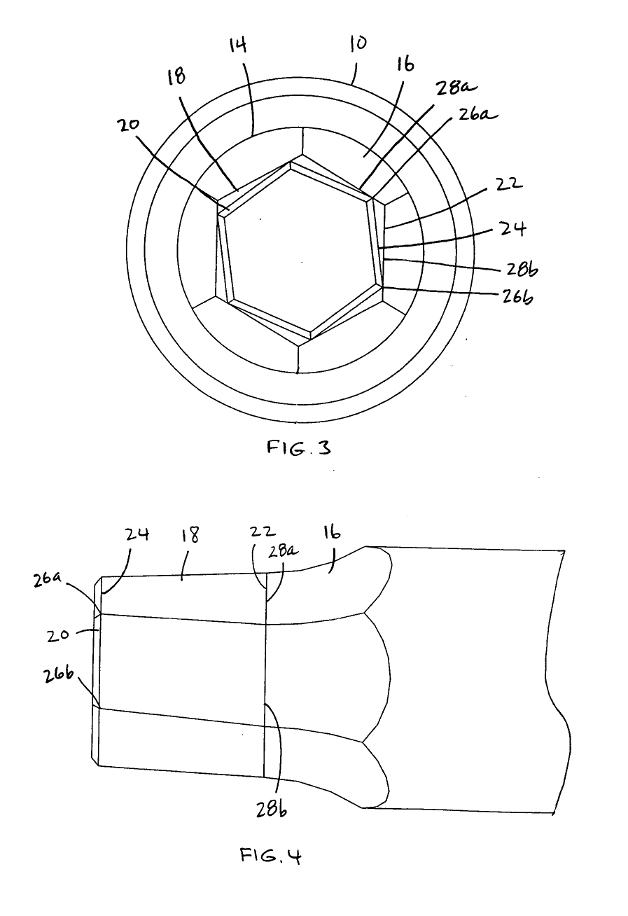

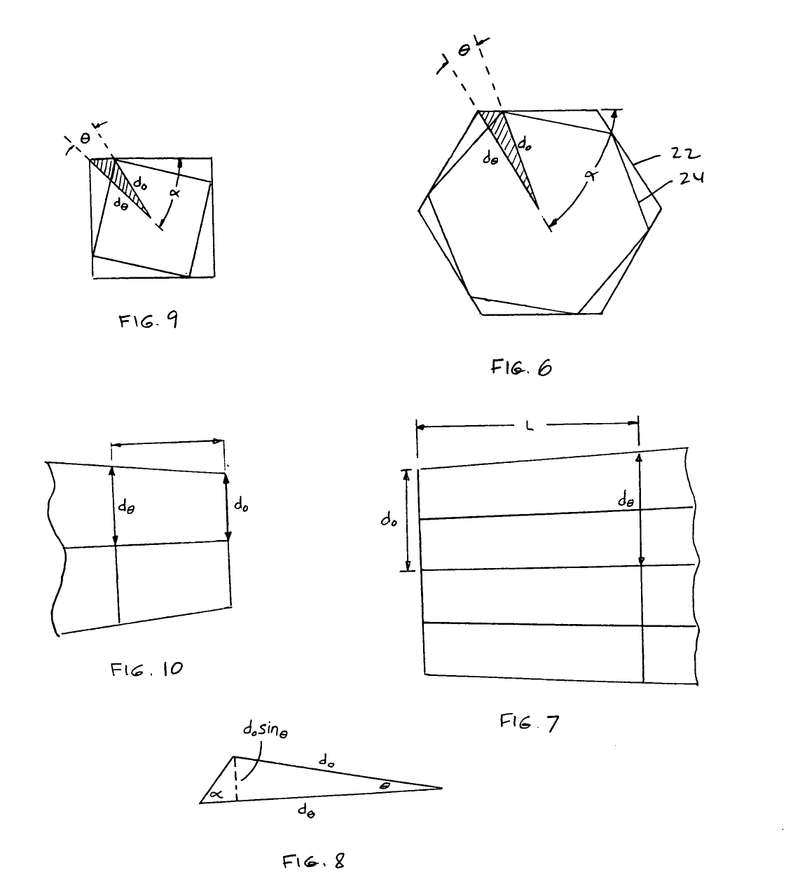

Turning now to FIGS. 1 through 4, a driver 10 for a fastener is shown. The driver 10 includes a proximal shaft 12 which is adapted with a non-circular cross-section for engagement by a rotary tool. Alternatively, the shaft 12 may be provided with a handle 13 for manual operation, as is well known in the art. The distal end of the driver 10 includes a tip 14 which is subject to a relatively steep taper 16 to step down in size to approximate the size and shape of a socket 30 of a fastener 32 to impart rotational force thereto (FIG. 5). More particularly, the end 18 of tip 14 is tapered and twisted and along its length has a cross-sectional shape which corresponds to a regular polygon with N sides, where N≧three. The end 18 of the tip 14 includes broken distal edges 20.

According to one embodiment of the invention, the end 18 of the tip 14 is hexagonal in cross-section (i.e., N=6), and thus adapted to drive fasteners with a hex socket. When viewed end on, the largest hexagon 22 defined by the end 18 circumscribes the smallest hexagon 24 defined thereby such that the corners (e.g., 26a, 26b) of the smallest hexagon lies at the sides (e.g., 28a, 28b) of the largest hexagon. Furthermore, the corner edges of the hexagons lie in planes parallel to the longitudinal axis of the hexagon. This permits the edges to dig themselves evenly into the facets of the fastener socket. This relationship holds true for the continuum of hexagon cross-sections along the tapering end portion 18.

This twisting and tapering configuration facilitates engagement within a fastener socket and provide planar contact along each side of the polygonal shape as well as along the edges of the tapering end portion 18 of the driver.

With reference to FIGS. 6 through 8, the optimum twist angle θ across a tapered regular polygonal tip having a length which engages within the socket of the fastener can be determined by trial and error, where

dₒ=diagonal at hexagon 24 at the start of the twist and taper (i.e., at the end of the tip, not including the leading bevel),

d_{θ}=diagonal at hexagon 22 at angle θ and distance L on the tip, and

L=distance of engagement of the tip within a socket of the fastener.
Referring to FIG. 8, shown is a representation of the triangle formed in FIG. 6 (in shaded lines), and representative of similar triangles that would be formed between two N-sided regular polygons in other embodiments. For example, with reference to FIGS. 9 and 10, a square driver constructed according to the invention also defines a triangle as shown in FIG. 8. With reference to FIG. 8,

$$\begin{matrix}{d}_{θ} = {d}_{o} cos θ + \frac{{d}_{o} sin θ}{tan α} , where \\ α = 90 - \frac{180}{N} , N = number of sides of the polygon & ( 1 ) \\ {d}_{θ} = {d}_{o} cos θ + \frac{{d}_{o} sin θ}{tan ( 90 - \frac{180}{N} )} & ( 2 )\end{matrix}$$

From the above, the design criteria is set as follows: determine the available engagement length L of the driver tip within the socket; determine dₒ to provide proper clearance to facilitate entrance of the driver tip into the socket; and determine the required d_{θ} to ensure proper interference into the socket of the fastener. Then using trial and error, determine θ (over distance L) so that θ satisfies Equation (2) for the number of sides N of the polygon. It should be noted that while Equations (1) and (2) were developed using diagonal distances d₀ and d_{θ}, these values can be substituted to corresponding flat-to-flat distances across the hexagon (and in to any even number sided regular polygon). This is because of the proportionality between of the diagonal-to-diagonal and flat-to-flat distances. For example, in a regular hexagon, the flat-to-flat distance will be square root 3×d, where d is the diagonal from the center to one corner.

By way of example, in one manufactured driver, the tip 18 has an engagement length L which is 0.100 inch, defines a smallest distal hexagon corresponding to a dₒ of 0.049 inch, and defines a largest proximal hexagon corresponding to a d_{θ} of 0.0525 inch. Placing such values into equation (2) and using trial and error to solve for θ, it can be determined that a preferred twist angle θ is approximately 7.56°. Given typical manufacturing tolerances, approximating θ with ±10% of the determined results should provide desirable results. With such twist angle, the sides of the tip of the driver along an upper portion thereof (adjacent entry into the socket) will lie against the facets of the socket and impart excellent torque transmission to the fastener. In addition, the edges of driver by making contact against the sides of the socket distribute stresses to thereby provide a system with overall low contact stress. Furthermore, insertion of the tip into the socket of the fastener is facilitated by the tapered design, and the fastener is retainer on the driver via engagement of the edges of the driver tip against the sides of the socket.

There have been described and illustrated herein embodiments of a driver for a fastener having a socket. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

1. A driver and fastener system, comprising:
a) a fastener having a non-twisted socket with facets, a cross-section through said socket defining a regular polygon; and
b) a driver with a shaft having a tip with sides meeting at edges, said tip being tapered along its length, wherein a first cross-section along said length defines a regular polygon of a first size and a second cross section along said length defines a regular polygon of a relatively smaller second size, said regular polygons being rotationally offset relative to each other,
wherein when said tip is inserted into said socket, said sides of the tip of the driver adjacent entry into the socket lie against said facets of the socket and said edges of said tip contact the sides of the socket.

2. A system according to claim 1, wherein:
when said tip is viewed end on, said polygon defined by said first cross-section appears to circumscribe said polygon defined by said second cross-section.

3. A system according to claim 1, wherein:
said regular polygon is a hexagon.

4. A system according to claim 1, wherein:
said regular polygon is a square.

5. A system according to claim 1, wherein:
said shaft has a proximal end which defines a non-circular cross-sectional shape.

6. A system according to claim 1, wherein:
said shaft has a proximal end which is provided with a handle.

7-9. (canceled)

10. A driver and fastener system, comprising:
a) a fastener including a non-twisted socket with a depth and which defines a regular N-sided polygon shape; and
b) a driver including a shaft with a tip having a length L substantially corresponding to said depth, said tip extending between an end of said tip and a location on said tip, wherein cross-sections through said tip define regular N-sided polygons, and said tip being tapered along said length such that a first N-sided polygon defined at said end is smaller than a second N-sided polygon defined at said location, and said tip being twisted at an angle such that said first and second N-sided polygons are rotationally offset relative to each other.

11. A system according to claim 10, wherein:
said angle is substantially constant and within ten percent of θ, where θ is determined from trial and error by,
$${d}_{θ} = {d}_{o} cos θ + \frac{{d}_{o} sin θ}{tan ( 90 - \frac{180}{N} )} , where$$
dₒ is a diagonal from a center of said first N-sided polygon to a corner of said first N-sided polygon, and
d_{θ} is a diagonal from a center of said second N-sided polygon to a corner of said second N-sided polygon at said constant angle and distance L.

12. A system according to claim 10, wherein:
when said tip of said driver is viewed end on, said second N-sided polygon appears to circumscribe said first N-sided polygon.

13. A system according to claim 10, wherein:
said regular N-sided polygon is a hexagon.

14. A system according to claim 10, wherein:
said regular N-sided polygon is a square.

15. A system according to claim 10, wherein:
said shaft has a proximal end which defines a non-circular cross-sectional shape.

16. A system according to claim 10, wherein:
said shaft has a proximal end which is provided with a handle.

17. A system according to claim 10, wherein:
said tip adjacent said point makes planar contact with a facet of socket.

18. A system according to claim 1, wherein:
said socket is non-tapered.

19. A method of driving a fastener, comprising:
a) providing a fastener having a non-twisted socket defining a regular polygon; and
b) providing a driver with a shaft having a tip with a length adapted to be inserted into the socket, said driving tip being tapered along its length and twisted at a constant angle, wherein a cross-section through the tip defines a regular polygon;
c) inserting the tip into said socket; and
d) driving the fastener with the driver.

20. A method according to claim 19, wherein:
said socket includes a plurality of facets,
said tip includes sides which meet at edges, and
said inserting includes inserting said tip into the socket such that the sides of the tip of the driver adjacent entry into the socket lie against the facets of the socket and the edges of the tip contact the sides of the socket such that the fastener is retained on the driver as a result of engagement of the edges of the tip against the sides of the socket.

21. A method according to claim 19, wherein:
said regular polygon is a square.
